(19) United States
(12) Patent Application Publication
(10) Pub. No.: US 2026/0266098 A1
(43) Pub. Date: Sep. 10, 2026

(54) MODULAR CENTRAL LOCKING AND UNLOCKING PADLOCK

(71) Applicant: LEGUTEC INICIATIVAS TECNICAS, S.L., Valencia (ES)

(72) Inventor: Salvador Gabriel Delhom Muñoz, Valencia (ES)

(21) Appl. No.: 19/561,051

(22) Filed: Mar. 9, 2026

(30) Foreign Application Priority Data
Mar. 10, 2025 (ES) ES P 202530200

(51) Int. Cl. E05B 67/00

(52) U.S. Cl. CPC E05B 67/003

(57) ABSTRACT

The invention relates to a modular padlock having a lock wherefrom all opening and closing elements are controlled by locking and unlocking the branches of the modular padlock. The main branches of the lock are directly linked to that lock and the secondary branches are fastened to the primary or other secondary ones through a mechanism that is locked or free depending on the locking or opening position of the single lock.

### CROSS-REFERENCE TO RELATED APPLICATIONS

This Application claims the benefit of and priority to Spanish Application No. ES P 202530200 filed on Mar. 10, 2025, the contents of which are hereby incorporated by reference.

### FIELD OF DISCLOSURE

The invention, as its name suggests, relates to a modular padlock wherein the opening and closing of all the elements are governed from a single lock. With this lock, all possible branches of the padlock are locked or unlocked.

The main branches of the padlock are directly linked to that lock and the secondary branches are fastened to the primary or other secondary ones through a mechanism that is locked or free depending on the locking or opening position of the single lock.

The technical field to which the invention belongs is that of locks and padlocks.

### BACKGROUND

To avoid the risks of theft, it is common to use security elements, usually chains locked by a padlock, which immobilise an object or secure it to another fixed one preventing its movement or theft.

This is very common in the field of light vehicles such as bicycles or mopeds, its use also being common in many other fields such as displays, for example of jewellery, door locks, external security blinds, terrace furniture or work elements, among others.

Link chains, which are widely used, are relatively easy to break and, moreover, they do not allow a series of fasteners arranged at a distance from each other to be unlocked from a single lock.

To improve safety, another type of devices appeared, colloquially known as python, with an articulated tubular body based on the combination of tensile strength of a metal cable with the additional resistance provided by a metal shield, as shown in the Spanish utility model ES296085.

These devices, although they surpassed conventional chains in terms of resistance, were not very versatile as they did not allow the object to be tightened to a greater or lesser extent as the length was predetermined and also the location of the fasteners, male and female, at opposite ends of the tubular body.

Depending on the intended use, it is of interest to be able to fasten two or more objects separated from each other with a single device, forming two loops. It is the case of being able to fasten the two wheels of a bicycle or one wheel and the frame among others.

Patent U.S. Pat. No. 9,243,428 relates to a safety device that incorporates a ring at one end, another free ring that runs through the tubular body and that incorporates a lock, and a lock at the free end of the tubular body such that the end comprising the ring can form a loop by passing the opposite end through the ring while the end comprising a lock will form a loop by being fastened to the free ring lock. This system, although versatile, has weak points such as the rings that make it unsafe. On the other hand, it does not allow the formation of branches in a simple manner so its use is limited.

Patent U.S. Pat. No. 7,131,298 relates to a multiple lock whereto several branches can be fastened. These branches cannot in turn have other branches but instead their functionality is limited to generating a loop thanks to an existing ring or loop at one of its ends and through which they pass the filiform element. Its versatility is limited because it does not allow any configuration other than the execution of said loop and all the branches must come together in a central lock with a limited number of fastenings. These branches must be fastened to the central lock.

Patent ES2329322 relates to a safety device that joins a fixed body of a vehicle to a moving part thereof. No option is observed in the patent to configure the device beyond joining both to fulfil said function.

The object of utility model ES1055796U is a safety device formed by a series of tubular rings with a male base and a female base such that the male base of one is inserted into the female base of the following one by way of a ball and socket allowing some bending of the assembly. This registration also indicates the incorporation of an armouring that surrounds each of such tubular elements. This device does not allow its configuration, its length and the places of the fasteners being pre-determined. Furthermore, the rings that constitute it differ in essential elements from the rings of the invention object of the present patent.

The object of utility model ES1107206U is a safety device formed from different tubes of two different sizes where the smaller can be retracted within the larger, the entire assembly being traversed by a tensioning cable that allows the extension of the device and, subsequently, forces its retraction. The technical solution of said device does not allow the free configuration of the fastening points.

Other patents such as U.S. Pat. Nos. 1,539,301 or 1,545,660 are known which are background of tubular bodies for chains and padlocks.

Patent U.S. Pat. No. 3,933,015, also in the field of padlocks, relates to a multiple lock, that is, a locking element suitable for fastening or releasing various terminals of different branches of the padlock.

There are several patents related to a padlock that include, at one of its ends, a ring or loop that allows them to pass the other end to configure a loop, among them the following: U.S. Pat. Nos. 5,937,678, 9,506,274, 9,243,428.

Within the type of padlocks that have a ring or tie to configure a loop, we also find those that incorporate locking elements in that ring or loop to fix the dimension of the loop, an example of this being patents U.S. Pat. No. 3,696,647, US2005262904.

The applicant is the holder of patent EP3803155 relating to a configurable padlock, although on that occasion the attachment between the branches and the formation of loops was performed through a clamp part that clamped the body of the branch, for which two contiguous links had to be separated. This, among other things, prevented the branch from being covered with a plastic, fabric or any other material protector that not only protected the padlock, but also prevented the vehicle or element whereto it is applied from being grated on contact with the bare links.

None of the indicated documents allows the free configuration of a padlock with several branches independent of each other but that can be attached forming a single body and that from a single central lock they can all be locked or unlocked without the need to separate the links of the body from the branch.

### DESCRIPTION OF THE INVENTION

The modular padlock of interest has a lock wherefrom main branches start, which, in a preferred embodiment, are permanently attached to that lock. Optionally, secondary branches suitable for joining to another branch, main or secondary, in such a way that the opening or closing of the lock allows the locking of all the branches that, in each case, make up the padlock.

Such a padlock has great versatility as it can be configured by adding or removing branches, and convenience as it is possible to lock or unlock all of them at the same time, all without having to separate links to make a hole where a clamp part can be fixed. Not having to make an internal hole allows a covering of the branch body with fabric, plastic or any other material, which protects both the branch body and the objects whereon it acts.

To this end, the proposed modular lock comprises:

A central lock acting on a primary tensioner.

Primary and secondary branches all formed by tubular sections related to each other in an articulated manner, traversed from end to end by a flexible but not elastic cable. At one end of these branches there is an articulated ring together with its opening and closing mechanism.

The locking or opening of the articulated ring of the primary branches is directly governed by the primary tensioner and, in a preferred embodiment, these primary branches are attached to that primary tensioner in a constant manner.

The locking or opening of the articulated ring of the secondary branches is indirectly governed by the primary tensioner but also involves, for its locking or unlocking, a secondary tensioner. Both tensioners, primary and secondary, act in a chain. The secondary tensioner is arranged on the secondary branch at the opposite end to its articulated ring. This secondary tensioner acts complementarily with the articulated ring of another branch whereto it is fastened.

Each branch, primary or secondary, comprises an articulated ring having an open and a closed position. For this purpose, each articulated ring comprises:

A ring-shaped body, understood as a solid body that surrounds a central space wherein that solid body can be closed, in which case that central space is completely surrounded, or open thanks to a joint that allows at least part of the ring to be practicable, in which case that central space ceases to be totally surrounded.

To do this, the free end of the openable part of the ring has the form of a stop that will prevent the opening of the ring from being closed and locked. We will call that end the top of the ring.

Its opening and closing mechanism is arranged between the articulated ring and the branch, comprising:

An outer housing attached to the branch by one of its bases. The cable that connects this locking mechanism with a tensioner is inserted into this housing from the branch. The housing houses a jacket attached to the articulated ring and linked to the cable, preferably by a cable stop arranged inside the housing although they can be connected in other ways such as welding, tying, screws or any other. The jacket, attached to the ring, moves longitudinally inside the housing with that movement of the jacket being conditioned by the cable such that when the cable is tightened by the action of the tensioner, it drags the jacket and brings it closer to the base of the housing attached to the branch and the opening of the ring is locked, and when the cable is released, the jacket can move towards the opposite end of the housing, which is its open mouth, and the ring is released allowing its opening. The ring lock occurs because the ring stop is inside the housing mouth and the release occurs when the ring stop is outside the housing mouth.

In a preferred embodiment, to promote this locking and unlocking operation and prevent unwanted manipulation of the ring, the housing has cornice-shaped extensions in its mouth that protect the sides of the articulated ring.

The movement of the jacket when it approaches the base of the housing attached to the branch occurs because the cable is tightened by a tensioner and drags the jacket. In contrast, the movement of the jacket towards the mouth of the housing is free when the cable is released, although this movement can be helped by a spring, elastic, or any other system that, for example, accumulates energy when the cable is tightened and releases it when the cable is released by pushing the jacket.

The movement of the cable, tightening or releasing itself, is produced by the action of tensioners that can be primary or secondary.

The primary tensioner, in a preferred embodiment, comprises a cam which, in its movement, tensions or releases the cable from the at least one primary branch. Other means of generating the movement such as magnets, gears, servos or electric motors or others are not ruled out.

Also in a preferred embodiment, the movement of the cam occurs by the rotation of a handle that is locked or released by a keyed cylinder, although other ways of locking or releasing it are not ruled out, such as electronic means with codes, by means of a computer application or other means in combination or not with the possible means of movement that have been indicated as an example.

When this primary tensioner tightens the cable associated with a primary branch, the cable drags the jacket and blocks the opening of the articulated ring of that branch; in contrast, when that primary tensioner releases cable, the jacket, preferably helped by the action of a spring or elastic, can move towards the mouth of the housing recovering its position, the articulated ring protrudes from the mouth of the housing and the stop of the articulated ring is released, opening being possible.

The secondary tensioner is arranged in the secondary branches at the end opposite the articulated ring and comprises: A secondary housing, a secondary jacket, a cable linking the secondary jacket to the jacket of the hinged ring of the opposite end of the branch, and a secondary ring attached to the secondary jacket having a central space.

The cable may be attached to the secondary jacket by a stop, weld, fasteners, or any other means.

This secondary ring has longitudinal movement with respect to the secondary housing and can be retracted inside the body of the secondary housing in two positions.

In a tightened position, the secondary ring comes out of the housing sufficiently so that in its central space the solid body of an articulated ring of another branch is inserted and housed as a stop. In this exit movement, the secondary ring drags the secondary jacket and this in turn to the cable tightening it.

In a release position the secondary ring, now without any body housed in its central space, is retracted inside the secondary housing pushing the secondary jacket towards the base of the secondary housing and releasing the cable. In a preferred embodiment, the secondary ring is not completely retracted inside the housing but a portion suitable to be used as a handle is left outside and pulled out.

When the secondary ring is in the locking position, with its central space traversed by the solid body of the articulated ring of another branch, the cable is tightened and, at the other end of the branch, the cable has dragged the jacket and brought it close to the base of the housing and, therefore, has blocked the opening of the articulated ring.

Once the articulated ring is removed from the space of the secondary ring, this secondary ring is released and can be retracted inside the secondary housing, releasing the cable and allowing the articulated ring of its branch, arranged at the opposite end, to be unlocked.

The retracting movement of the secondary ring can be helped by a spring or other elastic that has accumulated energy in the output movement of the ring and releases it to favour its retraction.

In this way, by fastening the articulated ring of one branch to the secondary ring of another branch, a padlock with the desired shape and size can be configured and maintained, since a single primary tensioner will allow the cascading unlocking of the entire padlock.

As stated, in a preferred embodiment the main tensioner is permanently attached to the at least one main branch, although other options are possible wherein all branches are like the secondary branches and are removably fastened to the main tensioner.

A padlock with the proposed structure is versatile since thanks to the articulated rings it can be configured in loops because the inner space of the articulated rings allows it to be closed on the body of the branch. In the same way, due to their function as a latch, the articulated rings allow the attachment of several branches in an infinite way, because although they all depend, for their locking or unlocking, on a main tensioner, as the tensioning mechanism is independent in each branch, the possible clearances or deformations of the cable or defects in the mechanisms do not add up from branch to branch making the annexation of more than two or three infeasible, but the possibilities of attachment are infinite without loss in the performance of the mechanisms as they move away from the main tensioner.

On the other hand, since it is not necessary to separate the links to install a clamp part, as is the case in the known state of the art, the body of the branch can be covered with fabrics or plastics that protect it and protect the elements to which it is attached.

### BRIEF DESCRIPTION OF THE FIGURES

For a better understanding of the invention, the following figures are attached

FIG. 1 shows the central lock (1) with two main branches (2) whose articulated rings (5) have been closed on the body of the branches generating loops. The handle (3) that is locked or unlocked with the key is also observed.

FIG. 2 shows a secondary branch (4) (greatly shortened to facilitate its reflection into a figure) where the articulated ring (5) is seen in this case in a closed position, partially protruding from the housing (6), specifically by its mouth, this housing being attached to the body of the branch (7) by its base opposite the mouth. A housing mouth protection (18) is also visible.

At the other end of the branch body we find the secondary housing (8) with the secondary ring (9) protruding from the secondary housing and exposing its central space (10)

FIG. 3 shows in section the housing (6) and the articulated ring (5) in the closed position. The jacket (11) can be seen, in this case close to the base of the housing attached to the branch body, the cable stop (12) and the stop (13) of the articulated ring, the mouth (14) of the housing that brakes the stop (13) blocking the opening and the cable (15) that runs through the branch body (7) inside.

FIG. 4 shows the articulated ring (5) in an unlocked position, where the jacket (11) has moved towards the mouth (14) pushing the articulated ring (5) and releasing the stop (13) of the articulated ring favouring its opening. Behind the articulated ring it is possible to see the protection (18) of the rear part.

FIG. 5 shows the articulated ring (5) open.

FIG. 6 shows a secondary branch (4) in section where you can see the cable (15) that links the articulated ring mechanism (5) with the secondary ring mechanism (9). In this case they are in the locked position with the jacket (11) being close to the base of the housing attached to the body of the branch, while at the opposite end of the body of the branch, the secondary jacket (16) is away from the body of the branch and close to the mouth of the secondary housing (8) in such a way that the secondary ring (9) is outside the secondary housing exposing its inner space. A spring (19) is also observed that contributes to the return of the secondary jacket to its position close to the body of the branch. It can also be seen in the cable stop (12) in this case in the secondary jacket.

FIG. 7 shows a secondary branch attached to another branch (main or secondary), showing the articulated ring (5) of a reproduced branch partially inserted into the secondary ring (9) of the branch that is shown whole, thus preventing the ring from slipping and thus maintaining the locking of the articulated ring of the branch that is shown.

FIG. 8 shows the main tensioner where you can see the cam (17) whose rotation of 180° causes the movement of the two fixing parts (20) that tighten or release the cables (15) associated with them.

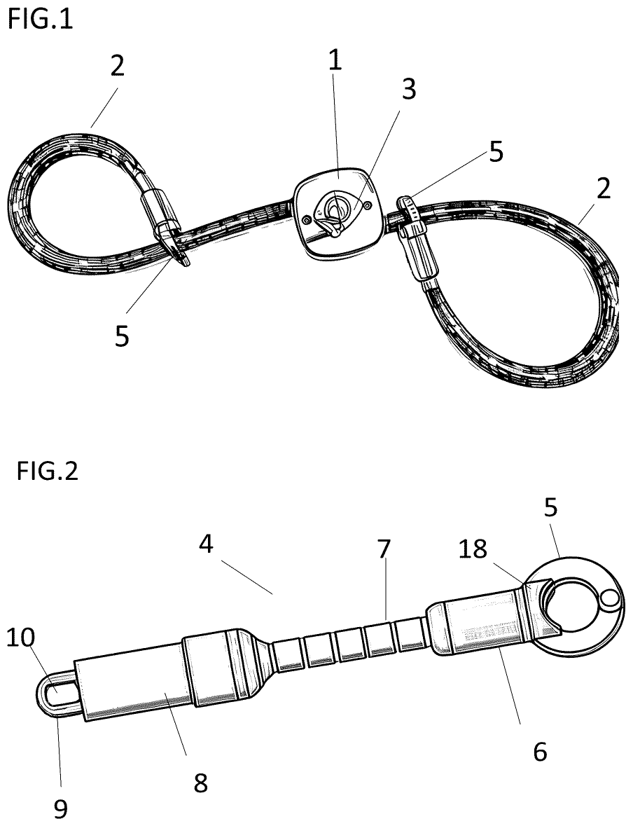

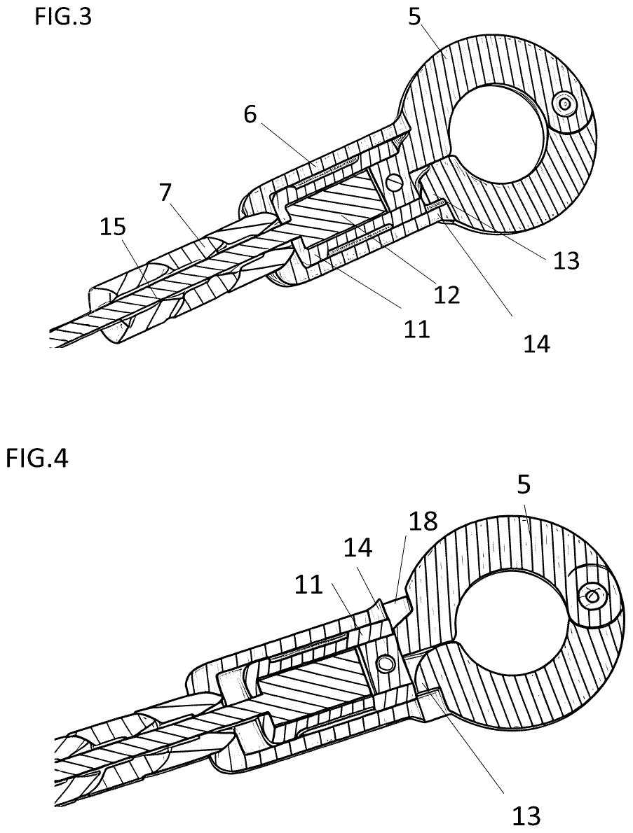

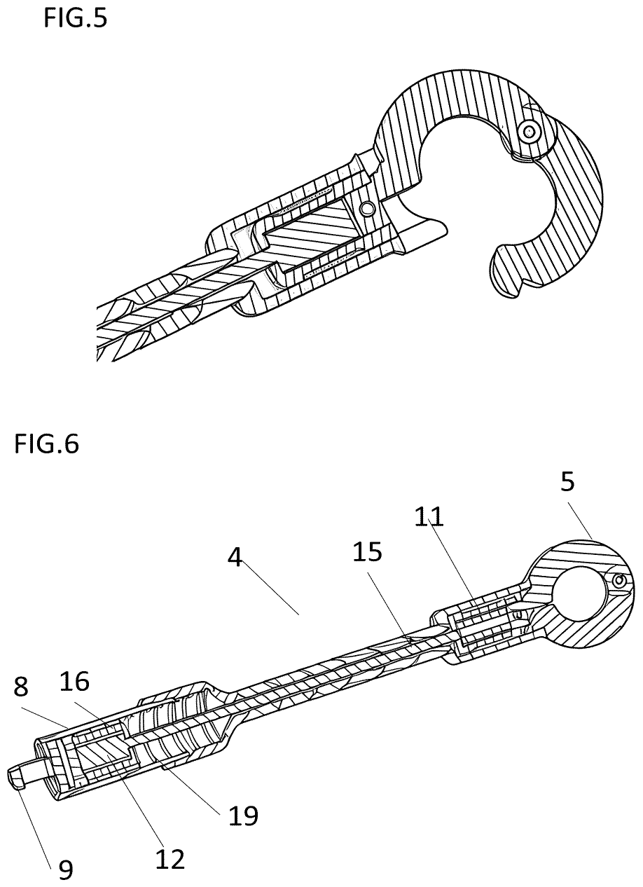

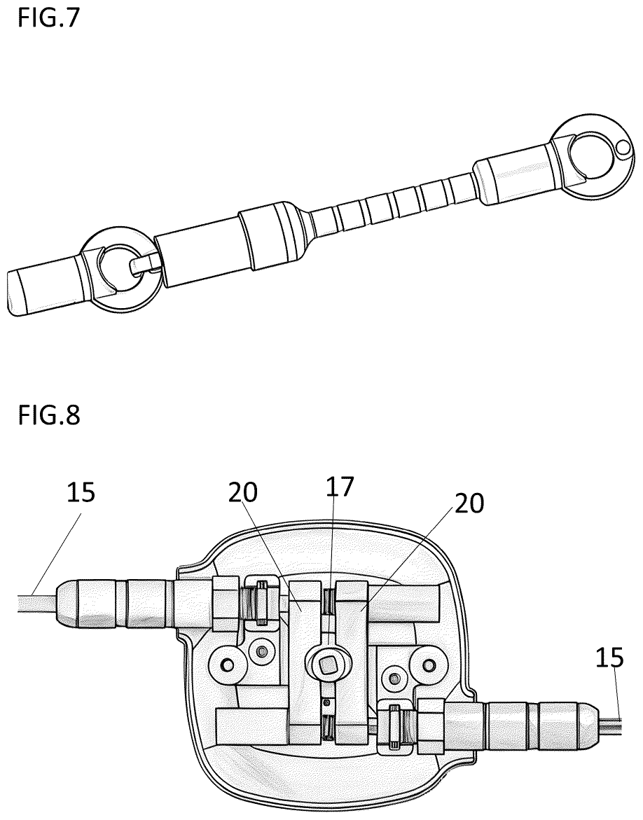

### DESCRIPTION OF AN EMBODIMENT

A description of an embodiment is described below that is not unique or limiting, but merely as an example.

The padlock of interest allows the infinite joining of branches with the obvious advantage that, by unlocking the primary branches, the unlocking of all the others is allowed.

To do this, the padlock comprises:

A central lock (1) that acts as a main tensioner tightening or releasing the cable (15) from the main branches (2).

A plurality of secondary branches (4).

Both the main and secondary branches comprise

A body of the branch (7) configured based on tubular sections articulated to each other traversed by a cable (15).

An articulated ring (5) is arranged at one of the ends of that branch body (7). The inner space of the ring is of greater diameter than that of the body of the branch so that the articulated ring can be closed on said body of the branch.

The mechanism that allows the opening and locking of the articulated ring comprises:

A housing (6) attached at one of its ends to the body of the branch. Within that housing and with longitudinal movement within the housing is a jacket (11) attached to the hinged ring (5). This jacket (11) houses the end of the cable (15) that has a cable stop (12) such that when the cable is tightened the cable stop (12) displaces the jacket towards the end of the housing attached to the body of the branch. As the articulated ring (5) is attached to the jacket, it is also displaced by being partially inserted into the mouth (14) of the housing.

The mouth (14) of the housing prevents the articulated ring (5) partially inserted in the housing from opening because it retains a stop (13) arranged at the end of the openable part of the articulated ring.

When the cable (15) is released, the jacket (11) moves towards the mouth (14) of the housing and the stop (13) of the hinged ring (5) is no longer retained by the housing so that the hinged ring can be opened.

How the cable is tightened or released varies depending on whether it is a main branch or a secondary branch.

In the case of the main branch, it is permanently attached to a main tensioner included in the central lock (1).

This tensioner comprises a cam (17) that is actuated by a handle that is locked or released by a keyed cylinder. The handle has a 180° rotation. This cam displaces the fixing parts (20) of the cables (15) from the main branches causing them to be tightened or released. The tightening or release of these cables will block or release the opening of the articulated rings (5) of the main branches.

In the case of secondary branches, the mechanism that allows the cable to be tightened or released is different.

As has already been said, each branch has, at one of its ends, an articulated ring (5) together with the mechanism that produces its locking or opening.

That mechanism depends on the tightening or release of a cable (15) that traverses the body of the branch (7) joining its ends.

Each secondary branch has, at the end opposite the articulated ring (5), a tightening and release mechanism for the cable (15) comprising:

A secondary housing (8) housing a secondary jacket (16) attached to a secondary ring (9) which is retractable inside the secondary housing. The secondary jacket is attached to the cable (15) and can move longitudinally inside the secondary housing in such a way that when the secondary ring leaves the housing, it drags the secondary jacket that moves towards the free end of the secondary housing tightening the cable and blocking the opening of the articulated ring at the other end of the secondary branch.

In contrast, when the secondary ring is retracted inside the secondary housing, the secondary jacket (16) moves towards the part of the secondary housing (8) attached to the body of the branch, releasing the cable (15) and allowing, at the opposite end of the branch, the jacket to move towards the mouth of the housing (6) releasing the opening of the articulated ring (5).

The inner space of the secondary ring (9) is suitable for the solid body of the articulated ring (5) of another branch to be inserted, thereby fixing the secondary ring in a locking position.

Once the articulated ring of another branch is unlocked and releases the secondary ring of the secondary branch which it blocks, that secondary branch will be able to unlock its articulated ring and so on and so forth infinite times.

What is claimed:

1. MODULAR CENTRAL LOCKING AND UNLOCKING PADLOCK comprising a central lock (1), at least one main branch and optionally one or more secondary branches, characterised in that it comprises a primary tensioner and in that each branch comprises:
A branch body (7) traversed from end to end by a cable (15).
At one of the ends of the branch body, an articulated ring (5) together with its opening and closing mechanism comprising:
A housing (6) arranged between the articulated ring and the body of the branch suitable for a jacket (11) to move longitudinally inside it.
The jacket (11) is attached to the articulated ring (5) whereto it transmits its movement, wherein the jacket (11) has a longitudinal displacement movement inside a housing (6) and wherein that jacket (11) is linked to a cable (15) such that when the cable is tightened it drags the jacket towards the base of the housing and when the cable is released, the jacket can move towards the mouth (14) of the housing.
The cable (15) when tightened or released defines a locking position or an opening position of the articulated ring (5) wherein, in a locking position, the jacket, dragged and fixed by the cable, is close to the base of the housing and the articulated ring (5) is partially inserted in the housing (6) such that a stop (13) comes up against the mouth (14) of the housing blocking the opening of the articulated ring and in an opening position, the jacket (11) is close to the mouth (14) of the housing, the articulated ring (5) has advanced towards the outside of the housing and the stop (13) is released allowing the opening of the articulated ring (5).
At the opposite end of the branch there is a tensioner attached to the cable (15) that tightens or releases it which, in the case of a main branch, will be a main tensioner and in the case of a secondary branch will be a secondary tensioner.

2. MODULAR CENTRAL LOCKING AND UNLOCKING PADLOCK according to claim 1, characterised in that the primary tensioner comprises a cam (17) that in its rotation displaces fixing parts (20) with each fixing part being associated with the cable (15) such that the displacement of each fixing part, depending on its direction, tightens or releases the associated cable.

3. MODULAR CENTRAL LOCKING AND UNLOCKING PADLOCK according to claim 2, characterised in that the cam (17) is associated with a handle (3) whose rotation can be locked or released by the action of a keyed cylinder.

4. MODULAR CENTRAL LOCKING AND UNLOCKING PADLOCK according to claim 1, characterised in that each secondary tensioner comprises:
A secondary housing (8) and a secondary jacket (16) wherein the secondary jacket is attached to a cable (15) and a secondary ring (9) and wherein the secondary jacket has longitudinal displacement movement within the secondary housing.
The secondary ring (9) has a central space suitable for the solid body of an articulated ring of another branch to be inserted therein and wherein when the secondary ring is retracted inside the secondary housing the secondary jacket is close to the body of the branch and the cable (15) is released, and when the secondary ring comes out of the housing, it drags the secondary jacket towards the free end of the secondary housing and this secondary jacket in turn drags the cable (15) tightening it.

5. MODULAR CENTRAL LOCKING AND UNLOCKING PADLOCK according to claim 4, characterised in that when the secondary ring is inserted by the solid body of an articulated ring of another branch, the cable is tightened and its movement is prevented and the articulated ring of that branch in the blocking position.

6. MODULAR CENTRAL LOCKING AND UNLOCKING PADLOCK according to claim 4, characterised in that when the secondary ring is retracted inside the secondary housing, the cable is released and the articulated ring of that branch in the opening position.

7. MODULAR CENTRAL LOCKING AND UNLOCKING PADLOCK according to claim 4, characterised in that elastic elements contribute to the movement of the cable (15).

8. MODULAR CENTRAL LOCKING AND UNLOCKING PADLOCK according to claim 1, characterised in that the cable (15) and the jacket (11) are attached by a cable stop (12) such that when the cable is tightened, it drags the jacket and the articulated ring (5).

9. MODULAR CENTRAL LOCKING AND UNLOCKING PADLOCK according to claim 4, characterised in that the cable (15) and the secondary jacket are linked by a cable stop (12) such that when the secondary ring comes out of the secondary housing, it drags the secondary jacket (16) and this secondary jacket drags the cable (15) and fastens it.
